(19) United States
(12) Patent Application Publication
(10) Pub. No.: US 2014/0052304 A1
(43) Pub. Date: Feb. 20, 2014

(54) DYNAMIC ENFORCEMENT OF POWER MANAGEMENT POLICY AND METHODS THEREOF

(71) Applicant: Infosys Limited, Bangalore (IN)

(72) Inventors: Sunil Kumar Vuppala, Katnataka (IN); Animikh Ghosh, West Bengal (IN)

(73) Assignee: Infosys Limited, Bangalore (IN)

(21) Appl. No.: 13/969,450

(22) Filed: Aug. 16, 2013

(30) Foreign Application Priority Data
Aug. 16, 2012 (IN) 3380/CHE/2012

(51) Int. Cl. H02J 4/00

(52) U.S. Cl. CPC H02J 4/00
USPC 700/295

(57) ABSTRACT

Systems and methods are disclosed for a policy-based, power consumption management of resources. Power consumption data is relayed to an event management system for conducting a pattern analysis of the resources based on historical values and external factors. The event management system may provide a graphical interface for implement decisions pertaining to resource management and effective policy enforcements. The energy management system is further configured to communicate with a data layer to receive measured values.

### RELATED APPLICATION DATA

This application claims priority to India Patent Application No. 3380/CHE/2012, filed Aug. 16, 2012, the disclosure of which is hereby incorporated by reference in its entirety.

### FIELD OF THE INVENTION

The present disclosure relates in general to the field of power management, and more particularly, to a power management system for monitoring, controlling and reporting the consumption of power by plug-in devices, and the like.

### BACKGROUND

Minimizing the power wastage has become a requirement towards sustainability. There can be a lot of wastage of power by a resource, in any entity. These resources can be primarily considered to be of two types: entity resources and miscellaneous resources. Entity resources would refer to resources utilized by an entity to conduct day to day activities, for example, desktop computers, laptops and copiers. Miscellaneous resources would refer to resources, for example, kitchen resources personal electronic devices and water coolers. For the purposes of this disclosure, these would be collectively referred to as ‘resources’. Each of these resources draws power and contributes to plug load. Power may be drawn when resources are in standby mode or not performing their primary function. The standby power use can be a significant contributor to plug loads. The term ‘plug load’, as used herein, refers to the power consumed by any resource that is plugged into a socket.

There exist separate systems for monitoring and controlling the high power loads of resources in a building using Building Management Systems (hereinafter referred to as ‘BMS’) for monitoring and controlling of high power loads in a building such as HVAC (heating, ventilation and air-conditioning) and smart plugs for controlling plug loads. A Building Management System (hereinafter referred to as ‘BMS’) is a system that can calculate the pre-set requirements of the building and control the building to meet the power requirements. Programs within these systems use captured information to decide the necessary level of control for resources within a building. The term ‘smart plugs’, as used herein, are typical plug strips which incorporate additional technologies to manage one or more resources. For example, smart plugs may incorporate technology to automatically disconnect power to certain resource when not in use. Smart plugs vary in design, but typically employ sensors, for example, occupancy sensors, load sensors, and timers.

The current resources do not have a reliable method to provide direct feedback for the power consumption by a resource. Typically a consumer has a periodic utility bill that allows for a comparison of the power costs from before and after the resource was installed. The cost of the consumed power shown in the utility bill does not take into account external factors, for example, temperature, rainfall, and hours of daylight, to allow a consumer to determine whether the usage of resource has actually resulted in a reduction in power consumption and/or an improved operational efficiency of the power consuming resources.

There exists a need to provide integrated solutions to extend BMS to plug loads so as to detect the power wastage, to adapt a power management policy implemented for an entity at the resource level. Most power management policies in an entity are time based and may not suffice to minimize power wastage based on recurrent events. The resource utilization information can be more effective by taking into account the real time information. Real time resource information can also be used to define effective power management policies. Further, resource utilization information correlated with power consumption is much needed.

The disclosure proposes an improved method and system for identifying power consumption patterns at each consumption point so as to curb the identified power wastage and make resources adaptable to power management policies.

### SUMMARY

Aspects of the disclosure relate to a system and method for identifying power consumption patterns at each consumption point so as to curb the identified power wastage and make resources adaptable to power management policies.

It is therefore one object of the present disclosure to provide systems and methods to identify the power consumption pattern at each power consumption point.

It is another object of the present disclosure to manage the power consumption by taking into account one or more external factors.

It is yet another object of the present disclosure to enable automatic enforcement of power management policies by conducting a pattern analysis of the resources.

The above as well as additional aspects and advantages of the disclosure will become apparent in the following detailed written description

### BRIEF DESCRIPTION OF THE DRAWINGS

The aspects of the disclosure will be better understood with the accompanying drawings.

FIG. 1 (PRIOR ART) is a block diagram of a computing device to which the present disclosure may be applied.

FIG. 2 shows architecture for automatically monitoring and controlling resources of an entity in accordance with the present disclosure.

FIG. 3 shows a schematic block diagram to illustrate a method for automatically monitoring and controlling resources of an entity in accordance with the present disclosure.

While systems and methods are described herein by way of example and embodiments, those skilled in the art recognize that systems and methods disclosed herein are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-readable media for identifying power consumption patterns at each consumption point so as to curb the identified power wastage and make resources adaptable to power management policies. The embodiments described herein are related to management of power consumption at the resource level. While the particular embodiments described herein may illustrate the invention in a particular domain, the broad principles behind these embodiments could be applied in other fields of endeavor. To facilitate a clear understanding of the present disclosure, illustrative examples are provided herein which describe certain aspects of the disclosure. However, it is to be appreciated that these illustrations are not meant to limit the scope of the disclosure, and are provided herein to illustrate certain concepts associated with the disclosure.

It is also to be understood that the present disclosure may be implemented in various forms of hardware, software, firmware, special purpose processors, or a combination thereof. Preferably, the present disclosure is implemented in software as a program tangibly embodied on a program storage device. The program may be uploaded to, and executed by, a machine comprising any suitable architecture.

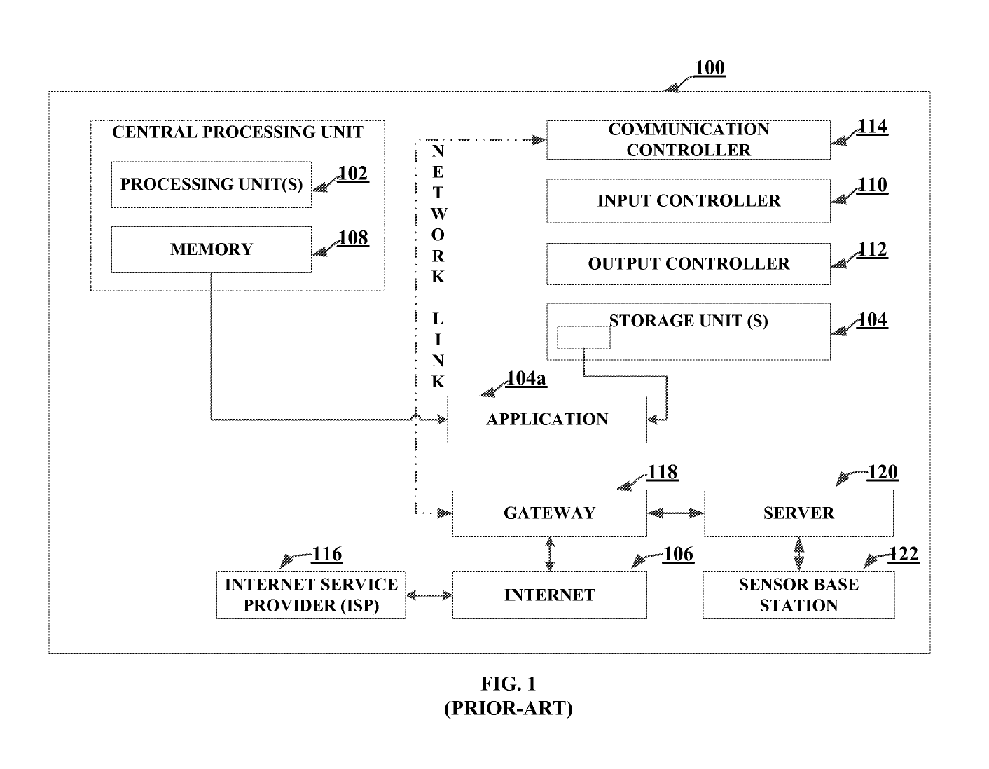

FIG. 1 (PRIOR-ART) is a block diagram of a computing device 100 to which the present disclosure may be applied. The system includes at least one processor 102, designed to process instructions, for example computer readable instructions (i.e., code) stored on a storage device 104. By processing instructions, processing device 102 may perform the steps and functions disclosed herein. Storage device 104 may be any type of storage device, for example, but not limited to an optical storage device, a magnetic storage device, a solid state storage device and a non-transitory storage device. The storage device 104 may contain an application 104a which is a set of instructions (i.e. code). Alternatively, instructions may be stored in one or more remote storage devices, for example storage devices accessed over a network or the internet 106. The computing device also includes an operating system and microinstruction code. The various processes and functions described herein may either be part of the microinstruction code or part of the program (or combination thereof) which is executed via the operating system. Computing device 100 additionally may have memory 108, an input controller 110, and an output controller 112 and communication controller 114. A bus (not shown) may operatively couple components of computing device 100, including processor 102, memory 108, storage device 104, input controller 110 output controller 112, and any other devices (e.g., network controllers, sound controllers, etc.). Output controller 110 may be operatively coupled (e.g., via a wired or wireless connection) to a display device (e.g., a monitor, television, mobile device screen, touch-display, etc.) in such a fashion that output controller 110 can transform the display on display device (e.g., in response to modules executed). Input controller 108 may be operatively coupled (e.g., via a wired or wireless connection) to input device (e.g., mouse, keyboard, touch-pad, scroll-ball, touch-display, etc.) in such a fashion that input can be received from a user. The communication controller 114 is coupled to a bus (not shown) and provides a two-way coupling through a network link to the internet 106 that is connected to a local network and operated by an internet service provider (hereinafter referred to as ‘ISP’) 116 which provides data communication services to the internet. Network link typically provides data communication through one or more networks to other data devices. For example, network link may provide a connection through local network to a host computer, to data equipment operated by an ISP 116. Network link uses a gateway 118 to connect to the internet 106 through the ISP 116. A server 120 may transmit a requested code for an application through internet 106, ISP 116, local network and communication controller 114. The server 120 is configured to receive data from a sensor base station 122. The sensor base station 122 is equipped with a wireless transmitting and receiving portion for exchanging data with one or more wireless sensor devices. The wireless sensor device may have a sensitivity detecting portion for receiving signals and a sensitivity transmitting portion for exchanging information with the sensor base station 122. Of course, FIG. 1 illustrates computing device 100 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be one or more servers, for example a farm of networked servers, a clustered server environment, or a cloud network of computing devices.

The described system and method utilize deployable sensors that can be used to track and/or control at least one resource in conjunction with a variety of external factors.

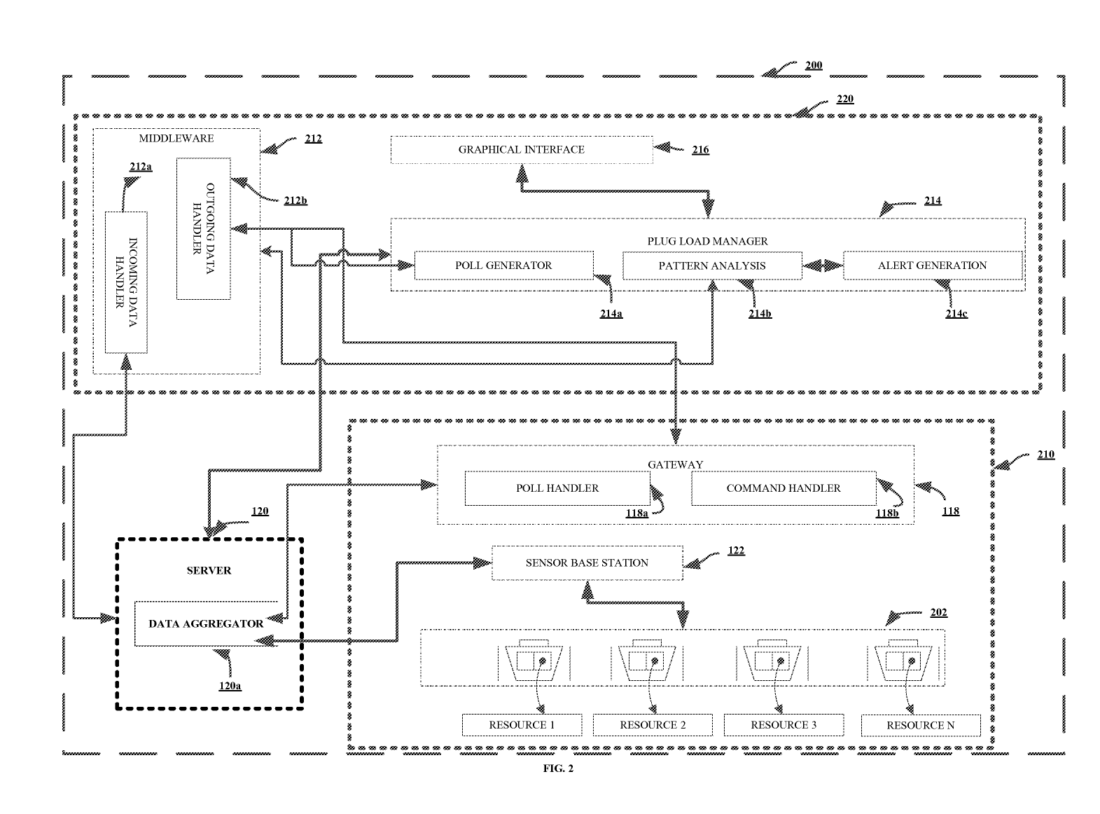

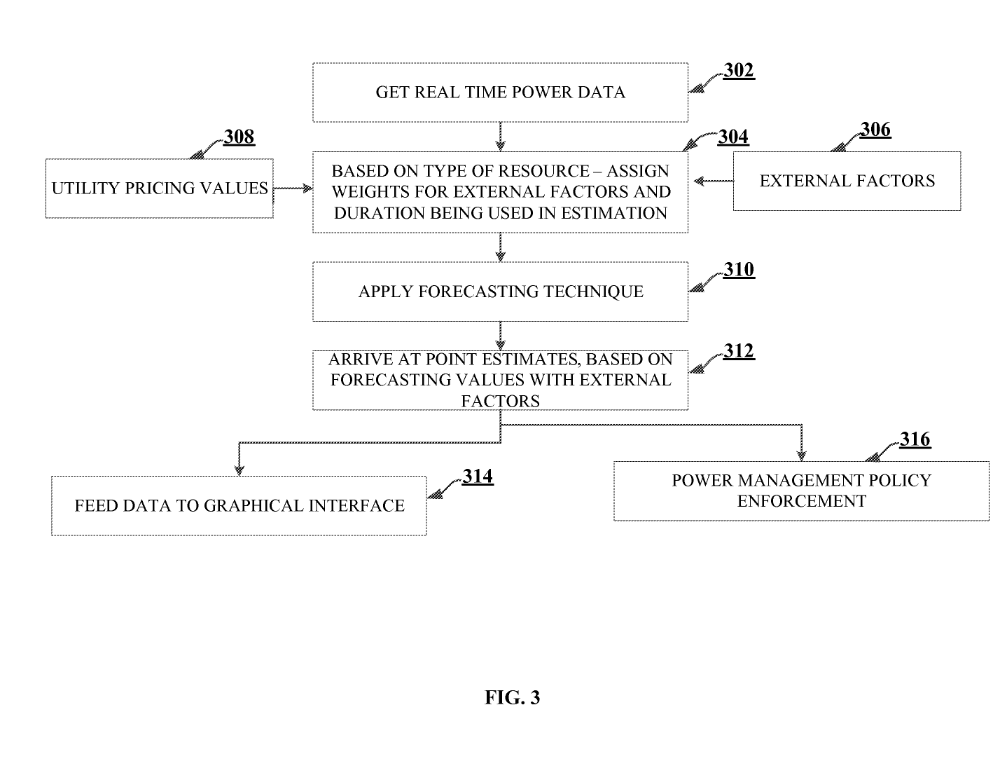

FIG. 2, in conjunction with FIG. 3 illustrates architecture 200 of a system and method, respectively, for automatically monitoring and controlling resources, according to an embodiment of the present disclosure. The system 200 is adapted to monitor and control the power consumption of at least one resource. It has three sub-systems, a data layer 210, a server 120 and a power management system 220. The data layer 210 includes at least one resource 202, a sensor base station 122 and a gateway 118. The power is measured instantaneously on all resources 202 and their data is relayed 302 back to the gateway 118, through the sensor base station 122 and the server 120, with the use of smart plugs. The gateway 118 has a poll handler 118a for routing the data received from server 120 to the middleware described as part of the power management system 220. The server 120 can integrate with at least one gateway 118 to centralize input from a plurality of smart plugs into the power management solution 220. Multiple gateways can be distributed based on the requirement and size, each controlling one or more resources. The resources 202 are connected to smart plugs that can monitor the power consumed on an instantaneous and accumulated basis from the resources. Smart plugs act as intelligent power outlets which measure and control connected resources 202 to maximize power efficiency. The smart plug contains at least one sensor node which is a unit with at least one sensor, the sensor node equipped with a transducer, microcomputer, transceiver and a power source. For the purposes of this disclosure, the terms, sensor and sensor node may be used interchangeably. As an illustrative example, at least one sensor may be directly connected to a smart plug, using a conventional electrical wiring system. A network of sensors may be arranged to monitor a variety of external conditions in addition to the power consumption of the resources 202. Examples of external conditions include, for example, environmental conditions. Environmental conditions may include, but are not limited to, temperature and humidity. Some resources may have sensors attached thereto, while other resources may not have sensors attached to them. The sensor communicates the data centrally to sensor base station 122 for local data aggregation of the power consumption readings of at least one resource 202. The sensor base station 122 may also be configured to collect sensor data from sensors which can measure external factors, for example, environmental sensors. Sensor base station 122 can include any device suitable for transmitting data to sensors, receiving data from sensors, and routing data to appropriate locations. Examples of a suitable sensor base station include, but are not limited to, a wired router, a wireless router and a network switch. Sensor base station 122 is also in communication with the sensors and the server 120 to receive data from the sensor base station 122. The server 120 may be implemented in many ways including, but not limited to, as a standalone general purpose computing device, a cluster of server and a mainframe. Server 120 may also run a data aggregator 120a to store historical data and data received from the sensor base station 120. Alternatively, the server 120 may communicate with other inventory systems to fetch historical data pertaining to at least one resource. The server 120 can report such data on pre-configured timelines to the event management system 220 using a gateway 118.

The Event Management System 220 has sub-components which include a middleware 212, a plug load manager 214 and a graphical interface 216. Event Management System 220 is an application which monitors the individual plug load power consumption and develops patterns of power consumption at those points. The data is fed back from the server 120 to the event management system 220 where data is available through a graphical interface 216. The power management system 220 has a middleware 212. The middleware 212 includes at least one application programming interface (API) to provide various services for the application. Essentially, it maintains system integration, security, communications, scalability, cross-platform support etc. Actual functions and capabilities can vary between service providers. According to an embodiment of the present disclosure, middleware 212 comprises an incoming data handler 212a for processing data packets from gateway 118 and an outgoing data handler 212b for processing resource operations from graphical interface 216. The plug load manager 214 further comprises of a poll generator unit 214a, a pattern analysis unit 214b and an alert generation unit 214c. The pattern analysis unit 214b receives data from the historical data from server 120 and the sensor base station 122 readings to apply correlation techniques on actual values and historical values of resources, to predict future values of the resources 202. These future values can be used to enforce or make amendments to power management policies in an entity. According to an embodiment of the disclosure, the pattern analysis can be conducted at an individual resource level where each resource is considered independently for the analysis. Alternatively, the pattern analysis can be conducted by creating groups of resources based on their type or purpose. Pattern analysis can also be conducted at an entity level.

The power management system 220 can be pre-configured to assign weightages 304 to resources for the purposes of predicting utilization values. The weights are assigned based on influence of external factors 306 and the duration for which the estimation is being applied 308. For the purposes of illustration, if usage of resources like coffee machine and water heater can have an impact based on external weather, occupancy and unit pricing but the appliances such as printers, scanners, desktops will have effect only on occupancy and unit pricing but not on external weather conditions.

Various forecasting techniques may be employed 310 by the pattern analysis unit 214b to predict the power demand of resources 202. The sensor base station 122 collects enough historical data to build an appropriate model for forecasting for each sensor node. Preferably, models such as the Auto Regressive Integrated Moving Average (hereinafter may be referred to as ‘ARIMA’) may be utilized for power consumption information collection scheme. As data collected from sensor nodes arrive at the sensor base station 122, these can be collected and maintained for each sensor node. Based on the historical data, time series analysis methods can be applied to build up a data model, which can be used to forecast future sampling values. The prediction values of power consumption by a resource are based on the ARIMA model within a predefined tolerance value from their actual values. It incorporates three terms, namely, the Auto Regressive (AR) term, the Integrated term, and the Moving Average (MA) term and the general notation is ARIMA (p;d;q). The ‘AR term or ‘p’ is a linear regression of the current value of the series against one or more prior, known, values of the variable of interest. It captures the dependency of current value and its nearest prior values. The MA term or ‘q’ refers to the number of lags in the error term. The ‘Integrated’ term or ‘d’ indicates how many times one takes the difference of the dependent variable. It is the actual values rather than the forecasted values that are used as the lagged dependent dataset, and thus the historical dataset is updated with the latest actual value when the forecasting process moves forward. Sensor base station 122 keeps the latest ‘p’ states of the corresponding time series, where ‘p’ is the order of the AR term for that sensor node. The ‘p’ values are required for the prediction of next values. Once the sensor base station 122 receives the respective values and transfers to the power management system 220 through server 120 and middleware 212, the power management system starts the pattern analysis. The prior values would include historical values of the resources 202, for example, but not limited to, cost and utility bills. Using the historical data of the power consumption of resources, point estimates can be arrived at 312, by:

=((w1*Pn)+((w2)*Pn−1)+((w3)*Pn−2)+ . . . (wn−1)*Pn−(n−1)))/(w1+w2+ . . . +wn−1)

Where:

P=number of lag values

W=weightage assigned to a resource

If there is no influence of external factors, then the point estimate is assumed to be of a minimum value. If the influence of external factors varies based on the resource, then the energy management system 220 can be configured to adapt this value. These values, along with the resource information can then be made 314 available through a graphical interface 216.

The graphical interface 216 is the communication and control system that aggregates resource power consumption data for automated control based on a set of goals determined by at least one power management policy. Graphical interface 216 can provide relevant and timely information to an entity about the performance of at least one resource. The entity can comprise of several types of users, for example, occupants, administrators, technicians and executives. The graphical interface 216 can be used by occupants of an entity to enter their personal resources within their own control. For example, an occupant could choose to dim or turn off the task lamp and not use a coffee maker during this time, these preferences would be used by the command handler 118b in deciding which loads to switch off. The data available on the graphical interface 216 can be used to manage or enforce these power management policies 316. According to an embodiment of the present disclosure, a configuration section can be used to add resources and select curtailment priorities. A user can navigate through the configuration page to change resource priorities. The different group of resources can also have corresponding priorities. The resources 202 can be viewed on a priority based model, in which resources with low priority settings can be turned off or their power use is altered before ones with higher priority. The graphical interface 216 enables a user to go through its list of connected and controllable resources, exerting control when needed to meet a goal of power reduction. When an event occurs, a user can select the appropriate resources to turn off and send a command to the command handler 118b through the outgoing data handler 208b to cut power to the appropriate outlet. The term ‘event’ as used herein refers to a set of business rules applied for information processes pertaining to customer assistance, for the management of at least one resource. The events include the domain knowledge coded in the form of rules.

According to another embodiment of the present disclosure, resources that have the potential to shed the most loads and have no restrictions can be listed first as possible solutions. An operation page can be used to list details about the resource operation state and connection state. An events page can provide information about the events which have occurred in the past along with the current and future predicted events. The term operation state, as used, herein, means a resource's position that indicates weather a resource is on or not. The term connection state, as used herein, means a resource's position that indicates whether a resource is connected or disconnected from an electric outlet. The power management system 220 may be configured to select the default operation state of a resource as ON or OFF (0 or 1). Although some resources such as a printer may have features that enable them to turn off automatically or enter low power manually, these low power resources may need to be monitored for aggregate power consumption. User can utilize the priority configuration to select priorities in the order of which the resources may be shut down, to override control from the gateway 118, to toggle resources on and off remotely through the graphical interface, to view power consumption data of resources that are being metered, and to view a schedule of upcoming demand response events.

According to an embodiment of the disclosure, the plug load manager 214 comprises a poll generator unit 214a to redirect control commands received from the graphical interface 216 to any of the sub-systems of the power management system 220 through the outgoing data handler 212b and the command handler 118b. These control commands can used to implement the desired strategy for each resource. Alternatively, the control commands can be used to query at least one resource or a group of resources. The sensors can also be queried to generate data describing specific external conditions.

According to another embodiment of the disclosure, the plug load manager 214 comprises an alert generation unit 214c for generating and transmitting an automatic notification to a user upon the occurrence of an event. The alert generation unit 214c is adapted to transmit an alert message through several mediums, which include, but is not limited to, an electronic mail and phone text message. The graphical interface 216 can also generate alerts for a sensor data threshold breach for power management policy enforcement.

Having described and illustrated the principles of the disclosure with reference to described embodiments and accompanying drawings, it will be recognized by a person skilled in the art that the described embodiments may be modified in arrangement without departing from the principles described herein.

What is claimed is:

1. A system to facilitate the management of at least one power consuming resource, the system comprising:
at least one plug load, each plug load disposed with a sensor node, the sensor node adapted to measure and transmit data packets to a sensor base station, wherein the data packets is representative of the power consumed by at least one resource;
a processing sub-system having a processor and a memory, the memory capable of storing software components for execution by the processor, the software components comprising:
a pattern analysis engine operative to analyze the power consumption of the resource, based on a pre-assigned prioritization;
an alert notification engine operable to co-ordinate with the pattern analysis engine for monitoring pre-configured parameters of an power management policy and generating alert notifications; and
a command handler engine operable to redirect commands for the functioning of the least one resource; and
a graphical interface coupled with the processing sub-system and operative to display a unified power consumption information for remotely controlling the functioning of the at least one resource using the command handler.

2. The system according to claim 1, wherein the command handler is configured to redirect commands for the functioning of the at least one resource by one of:
powering off;
powering on;
powering to a stand by state;
switching from a dynamic regulation to a permanent regulation;
rescheduling the operational timing; and
switching off before the scheduled time.

3. The system according to claim 1 further comprising a data aggregation engine operative to receive the data packets from the sensor base station.

4. The system according to claim 3, wherein the pattern analysis engine is operable to perform the steps comprising:
identifying a first set of meta-data for external data points and a second set of meta-data for power consumption of the at least one resource, from historical data, wherein the historical data values represent the data packets;
quantifying the first set of meta-data using a linear algebraic formulation;
designating weights for autoregressive integrated moving average (ARIMA) coefficients; and
generating an ARIMA model, for the sensor node of the resource, to arrive at point estimates of forecasts based on the second meta-data.

5. The system in accordance with claim 1, wherein the pre-assigned prioritization is selected from a group consisting of: the at least one resource; at least one building and at least one resource level or a combination of all.

6. The system in accordance with claim 1, wherein the alert notification engine is further operable to generate and transmit notifications to the graphical interface on account of power consumption exceeding a predefined limit.

7. The system in accordance with claim 6, wherein the graphical interface is further operable to cause a user to generate and send notifications to designated authorities for a power management policy violation.

8. A computer implemented method executed by one or more computing devices for facilitating the management of at least one power consuming resource, the method comprising:
receiving, from the one or more computing devices, a first meta-data representing measurement of external data factors and a second meta-data representing measurement of power consumption of at least one resource, wherein sensor nodes are disposed in plug loads of the at least one corresponding resource;
analyzing, using the one or more computing devices, the power consumption patterns of the at least one resource, based on a pre-assigned prioritization;
monitoring, using the one or more computing devices, an power management policy with pre-configured parameters based on the characterization of the at least one resource;
executing a command, using the one or more computing devices, to control the functioning of the least one resource; and
displaying, using the one or more computing devices, a unified dashboard showing visualizations of the power consumption information for remotely controlling the functioning of the at least one resource.

9. The computer-implemented method in accordance with claim 8, wherein the execution of a command is done by one of:
powering off;
powering on;
powering to a stand by state;
switching from a dynamic regulation to a permanent regulation;
rescheduling the operational timing; and
switching off before the scheduled time.

10. The computer-implemented method in accordance with claim 8, wherein the data packets is received from a sensor base station, the sensor base station adapted to communicate with the sensor nodes.

11. The computer-implemented method in accordance with claim 10, wherein the analysis of the power consumption is performed using the steps comprising:
quantifying the first set of meta-data using a linear algebraic formulation;
designating weights for ARIMA coefficients; and
generating an autoregressive integrated moving average (ARIMA) model, for the sensor node of the at least one resource, to arrive at point estimates of forecasts based on the second meta-data.

12. The computer-implemented method in accordance with claim 8, wherein the pre-assigned prioritization is selected from a group consisting of: the least one resource; at least one building and at least one resource level or a combination of all.

13. The computer-implemented method in accordance with claim 8, wherein notifications are generated and transmitted to the dashboard on account of power consumption exceeding a pre-configured limit.

14. The computer-implemented method in accordance with claim 8, wherein a user can generate and send notifications to designated authorities for a power management policy violation from the dashboard.

15. A computer readable medium having a set of instructions for execution on a computing device, the set of instructions comprising:
a receiving routine for receiving a first meta-data representing measurement of external factors and a second meta-data representing measurement of power consumption of at least one resource, wherein sensor nodes are disposed in plug loads of the at least one corresponding resource;
an analyzing routine for analyzing the power consumption patterns of the at least one resource, based on a pre-assigned prioritization;
a monitoring routine for monitoring an power management policy with pre-configured parameters based on the characterization of the at least one resource;
an execution routine for controlling the functioning of the least one resource; and
a graphical interface routine for displaying unified power consumption information for remotely controlling the functioning of the at least one resource.
